(19) United States
(12) Patent Application Publication
(10) Pub. No.: US 2013/0273877 A1
(43) Pub. Date: Oct. 17, 2013

(54) Low Cost Automotive Accident Alert System

(71) Applicant: AUTOMATIC LABS, INC., San Francisco, CA (US)

(72) Inventors: Thejovardhana S. Kote, San Francisco, CA (US); Ljubinko Miljkovic, San Francisco, CA (US); Ramprabhu Jayaraman, San Francisco, CA (US); David Theron Palmer, San Francisco, CA (US)

(73) Assignee: Automatic Labs, Inc., San Francisco, CA (US)

(21) Appl. No.: 13/860,003

(22) Filed: Apr. 10, 2013

Related U.S. Application Data
(60) Provisional application No. 61/623,409, filed on Apr. 12, 2012.

(51) Int. Cl. H04W 4/22

(52) U.S. Cl. CPC H04W 4/22
USPC 455/404.2

(57) ABSTRACT

An alert apparatus has a digital processor coupled to an accelerometer and wireless pairing circuitry for pairing wirelessly with a smartphone, software that executes operations or firmware, an OBD connector that monitors the onboard diagnostics system of a vehicle for specific information, monitors the accelerometer for deceleration exceeding a preset value, updates position of the automobile periodically, and, in the event of a determination that an accident has occurred, and transmits an alert signal to the smartphone via wireless pairing circuitry, which then sends alert communications to emergency services and contacts.

### CROSS-REFERENCE TO RELATED APPLICATIONS

The present application claims priority to Provisional Application Ser. No. 61/623,409, filed Apr. 12, 2012. The entire disclosure of that application is incorporated in its entirety at least by reference.

### BACKGROUND OF THE INVENTION

1. Field of the Invention

The present invention is in the technical area of automotive safety and emergency alert systems using existing cellular device technologies and the Internet.

2. Description of Related Art

Automotive accidents are a leading cause of death. Several options for accident alert systems are available, but those currently on the market have high-end features with price points that are prohibitive for the average consumer. Currently, there are no affordable options available to the average consumer. As such, drivers must rely on methods for alerting emergency services and contacts that may not be available in the aftermath of an accident.

### BRIEF SUMMARY OF THE INVENTION

In one embodiment of the invention an alert apparatus is provided, comprising a digital processor, an accelerometer coupled to the digital processor, wireless pairing circuitry for pairing wirelessly with a smartphone coupled to the digital processor, software executable on the digital processor from a non-transitory medium, and an onboard diagnostics (OBD) connector coupled to the digital process, enabling monitoring of an onboard diagnostics system of an automobile, and stored criteria for determining if an accident has occurred.

In one embodiment of the invention, the alert apparatus monitors the onboard diagnostics system of the automobile for specific information, as well as the accelerometer for deceleration exceeding a preset value, updates position of the automobile periodically, and, in the event of a determination that an accident has occurred, transmits an alert signal to the smartphone via the wireless pairing circuitry.

In another embodiment of the invention, the alert apparatus comprises Global Positioning System (GPS) circuitry coupled to the digital processor, and transmits global position to the cellular telephone along with the alert signal.

In another embodiment of the invention, the accelerometer is capable of determining changes in orientation that may indicate the automobile has flipped or rolled over. The fact of change in the vehicle's orientation may be transmitted to the cellular telephone along with the alert signal in the event of an accident. In another embodiment of the invention, deployment of one or more airbags is determined from the OBD system, and the facts of airbag deployment may be transmitted to the cellular telephone along with the alert signal. In yet another embodiment of the invention, the determination that an accident has occurred derives from any single event of rollover, deceleration beyond the present value, or deployment of one or more airbags.

In one embodiment of the invention, the alert apparatus connects to a smartphone having a digital processor, wireless pairing circuitry, and an application executing on the digital processor from a non-transitory medium.

In one embodiment of the invention, the smartphone application may provide a process that receives an alert from a paired device that an accident has occurred, which may then trigger pre-programmed alert communications to be sent to pre-configured destinations regarding the fact of an accident having occurred.

In one embodiment of the invention, the alert from the paired device may be accompanied by GPS coordinates, which are provided along with at least some of the pre-programmed communications. In another embodiment of the invention, the smartphone may have a Global Positioning System, and GPS coordinates are provided along with at least some of the pre-programmed communications. In yet another embodiment of the invention, the alert is accompanied by specific information or data about the accident, including one or both of rollover or deployed airbags.

In another embodiment of the invention, the pre-programmed communications include one or more of emails, text messages, or recorded voice messages. In yet another embodiment of the invention, the pre-programmed communications include an alert sent to an Internet-connect server that an accident has occurred.

In one embodiment of the invention, a system is provided comprising an alert apparatus having a digital processor, an accelerometer, wireless pairing circuitry, and an onboard diagnostics (OBD) connector, and is enabled to retrieve data from an automobile onboard diagnostics system, and to determine from local and retrieved data that an accident has occurred.

In another embodiment of the invention, a smartphone executing an application enabled to receive an alert from the alert apparatus, and to send pre-programmed communications to pre-configured destinations that an accident has occurred. In yet another embodiment of the invention, an Internet-connected server enabled to receive an alert from the smartphone, and to send pre-programmed communications to pre-configured destinations that an accident has occurred.

In one embodiment of the invention, the smartphone sends GPS coordinates along with pre-programmed communications. In another embodiment of the invention, one or more pre-programmed communications comprise requests for service from one or more emergency service organizations.

In one embodiment of the invention, a method is provided comprising the monitoring of onboard diagnostics information of an automobile by an alert apparatus having an accelerometer and wireless pairing circuitry, the determination by the alert device that an accident has occurred, sending an accident alert to a smartphone via wireless pairing circuitry, and transmission by the smartphone one or more pre-programmed communications to one or more pre-configured destinations as a result of receiving the alert.

In another embodiment of the invention, a method is provided wherein one of the pre-programmed communications is to an Internet-connected server that transmits one or more communications to one or more pre-configured destinations as a result of receiving the alert. In yet another embodiment of the invention, the smartphone may either receive GPS coordinates from the alert device, or generate the coordinates in the smartphone, and send the GPS coordinates along with one or more of the pre-programmed communications. In one embodiment of the invention, one or more of the pre-programmed communications may be a request for service from one or more emergency service organizations.

### BRIEF DESCRIPTION OF THE SEVERAL VIEWS OF THE DRAWINGS

FIG. 1 is an architectural diagram illustrating methods of communication in an embodiment of the invention.

FIG. 2 is a block diagram illustrating connectivity of an alert device in an embodiment of the invention.

FIG. 3 illustrates internal detail of the proprietary alert device of FIG. 2 in an embodiment of the invention.

FIG. 4 is a flow diagram illustrating operation of the proprietary alert device and associated software in an embodiment of the invention.

### DETAILED DESCRIPTION OF THE INVENTION

The inventor provides a device and system for alerting emergency services and a user's chosen contacts in the event of an automobile accident. Using the proliferation of smartphone technologies, application software, Bluetooth™ pairing, the Internet, and the communicative ability of these elements, the inventor provides a low-cost emergency alert system. The system and methods of the invention are described below according to the following embodiments.

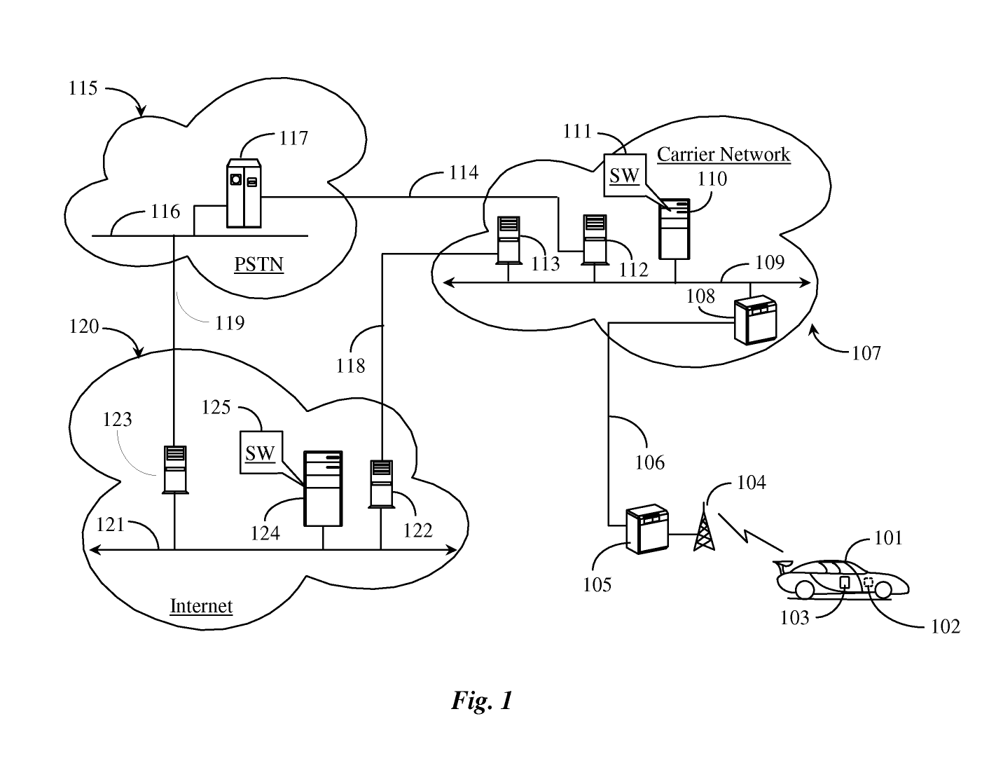

Referring to FIG. 1, in one embodiment of the invention, a typical automobile 101 that is equipped with an onboard diagnostics system and an OBD connector 102 may interact with an emergency alert device 103. Emergency alert device 103 connects to OBD connector 102 which connects to the onboard diagnostics system, and is paired with a Bluetooth™-capable smartphone 104. Smartphone 104 may interact with cellular tower 105 and local base station 106 using path 107 to communicate with carrier network 108.

Carrier network 108 operates using regional base station 109 and internal network structure 110, which connects to network server 111 running associative software 112. Carrier network 108 communicates with PSTN land line network 116 using gateway 113 and path 115, and also communicates with Internet 121 using gateway 114 and path 119. PSTN land line network 116 operates on land line trunk 117 and switch 118. PSTN land line network 116 communicates with Internet 121 using gateway 124 and path 120.

Internet 121 operates on Internet backbone 122 and network server 125 running associative software 126. Internet 121 communicates with PSTN land line network 116 using gateway 124 and path 120, and communicates with carrier network 108 using gateway 123 and path 119.

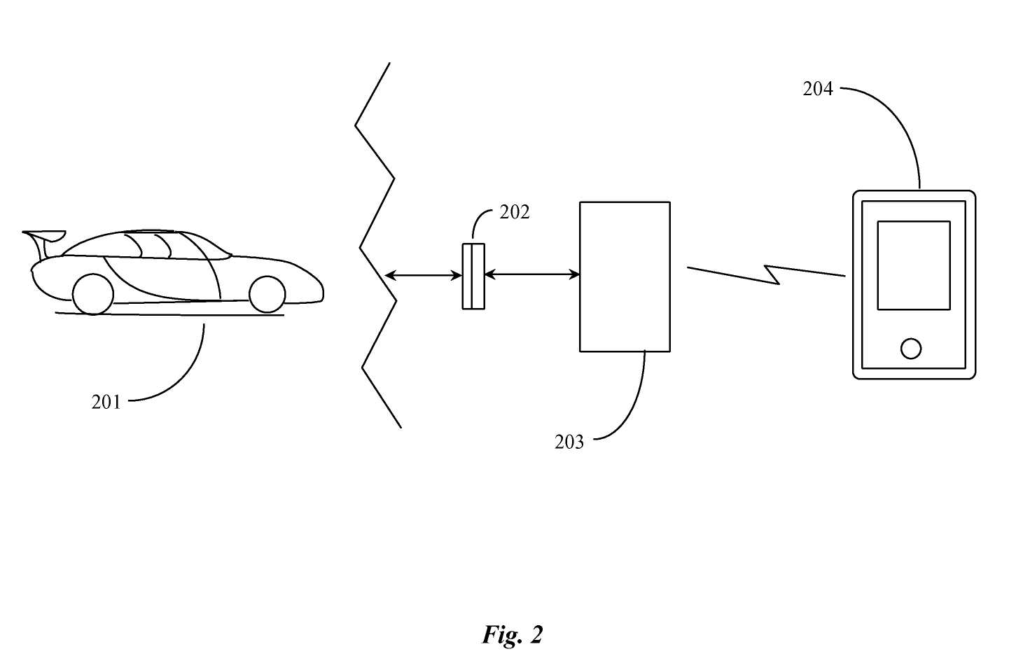

Referring now to FIG. 2, in one embodiment of the invention, automobile 101 having OBD connector 102, to which emergency alert device 103 can connect, may communicate critical data between the onboard diagnostics system and emergency alert device 103. Emergency alert device 103 may then communicate with smartphone 104 through Bluetooth™ pairing, relaying data that might activate application software 201 in the event of an accident.

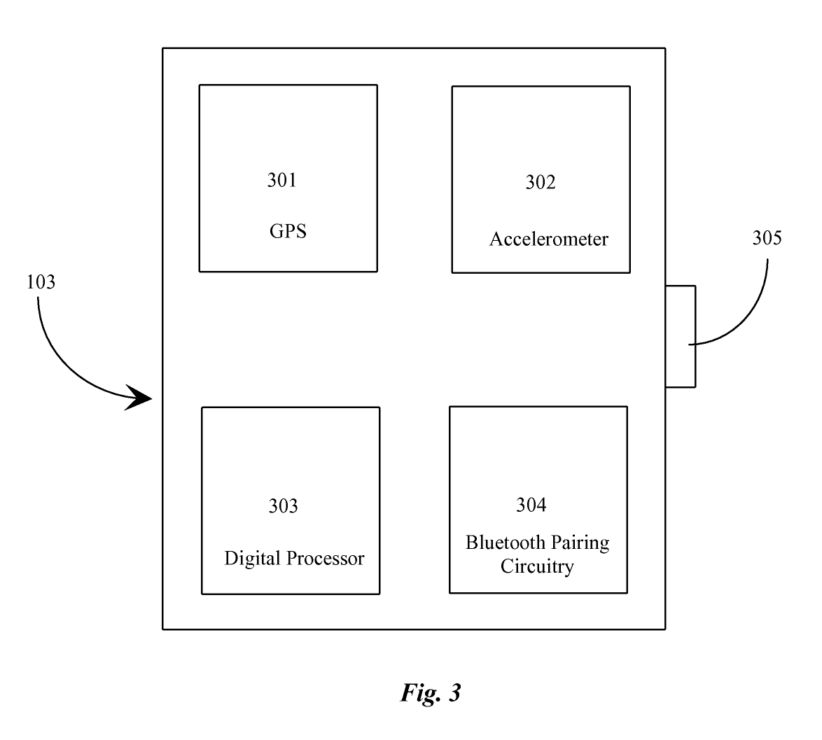

Referring now to FIG. 3, in one embodiment of the invention, emergency alert device 103 may contain the following elements: a Global Positioning System (GPS) 301, an accelerometer 302, digital processor 303 and Bluetooth™ pairing circuitry 304. Emergency alert device 103 connects to OBD connector 102 using plug 305. Accelerometer 303 is enabled to detect acceleration and deceleration. In the case of emergency alert device 103, sudden deceleration is a primary indicator of an accident. Firmware 303 assesses speed data from accelerometer 302, and through communication with OBD connector 102 through port 306, can determine whether or not the vehicle's airbags have been deployed. Using Bluetooth™ pairing circuitry 304, emergency alert device 103 may communicate with the operator's associative smartphone application 201.

In another embodiment of the invention, accelerometer 303 is enabled to detect changes in the orientation of automobile 101. For example, in normal operation, automobile 101 is upright and accelerometer 303 may be configured to recognize its orientation. In the event that automobile 101 changes orientation, either by flipping over or rolling as a result of an accident, accelerometer 303 may recognize the change, which would trigger communications operations to take place.

In another embodiment of the invention, emergency alert device 103 may not contain Global Positioning System (GPS) 301, instead relying upon the Global Positioning System (GPS) available in smartphone 104 or vehicle 101.

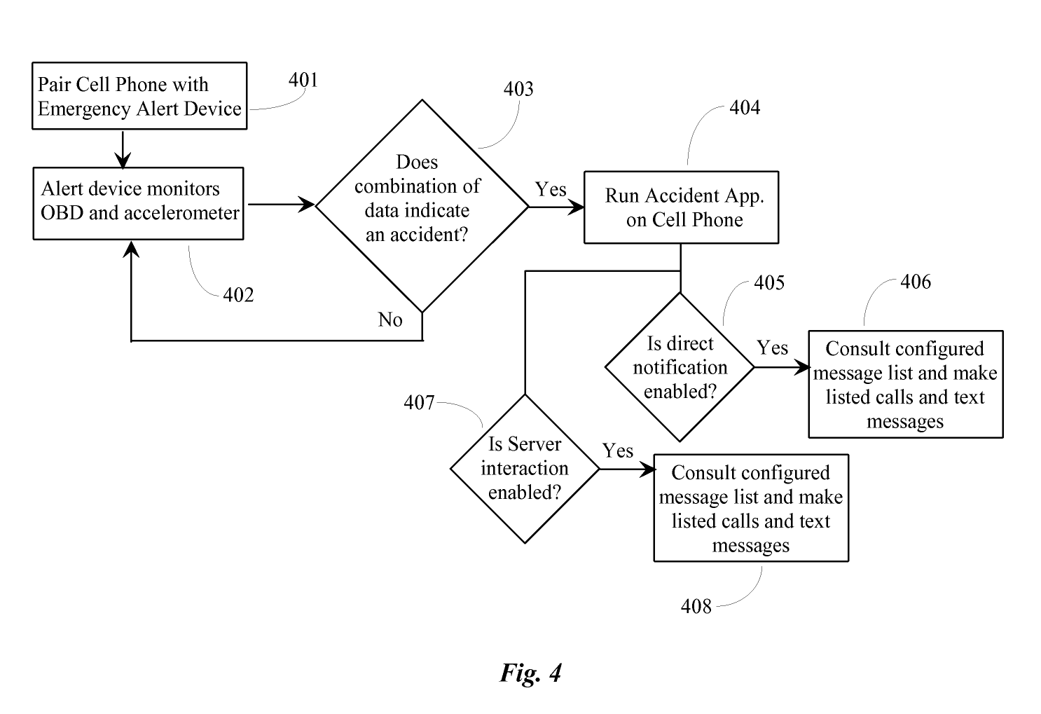

FIG. 4 is a flow diagram illustrating a process of alert communication in the event of an automobile accident in one embodiment of the invention. In one embodiment of the invention, assuming emergency alert device 103 is paired with smartphone 104 via Bluetooth™ at step 401, the device will monitor onboard diagnostics and accelerometer 302 at step 402. If the combination of data does not indicate an accident, the device will simply continue to monitor data. If the combination of data indicates an accident at step 403, the device will proceed to run accident application software 201 on the operator's smartphone 104 at step 404. If the user has indicated that direct notification is enabled at step 405, the application software will consult a configured message list and perform communication functions as requested at step 406 using carrier network 108. At step 407, if server interaction is enabled, application software 201 will alert server 125 which will execute SW 126 to consult a configured message list and perform communication functions as requested at step 408. These calls and messages may be implemented through the Internet as email or text messages, may be PSTN calls made via path 120, or may be cell calls made via path 119 to the cellular carrier network.

The embodiments described above are examples. Many alterations in these embodiments can be made within the spirit and scope of the invention. The invention is limited only by the claims that follow.

1. An alert apparatus comprising:
a digital processor;
an accelerometer coupled to the digital processor;
wireless pairing circuitry for pairing wirelessly with a smartphone, coupled to the digital processor;
software executable on the digital processor from a non-transitory medium;
an onboard diagnostics (OBD) connector coupled to the digital processor, enabling monitoring of an OBD system of an automobile; and
stored criteria for determining if an accident has occurred;
wherein the apparatus monitors the OBD system of the automobile for specific information, monitors the accelerometer for deceleration exceeding a preset value, updates position of the automobile periodically, compares real-time data with the stored criteria, and, in the event of a determination that an accident has occurred, transmits an alert signal to the cellular telephone via the wireless pairing circuitry.

2. The apparatus of claim 1 further comprising Global Positioning System (GPS) circuitry coupled to the digital processor, wherein the apparatus transmits global position to the cellular telephone along with the alert signal.

3. The apparatus of claim 1 wherein the accelerometer is capable of determining changes in orientation that may indicate the automobile has rolled over, wherein the fact of rollover is transmitted to the cellular telephone along with the alert signal in the event of an accident.

4. The apparatus of claim 1 wherein deployment of one or more airbags is determined from the OBD system, and the facts of air bag deployment are transmitted to the cellular telephone along with the alert signal.

5. The apparatus of claim 1 wherein the determination that an accident has occurred derives from any single event of rollover, deceleration beyond the preset value, or deployment of one or more airbags.

6. The apparatus of claim 1 wherein the wireless pairing circuitry is Bluetooth™ protocol compatible.

7. A smartphone comprising:
a digital processor;
wireless pairing circuitry; and
an application executing on the digital processor from a non-transitory medium;
wherein the application provides a process comprising:
receiving an alert from a paired device that an accident has occurred;
triggered by the alert pre-programmed communications to pre-programmed destinations regarding the fact of the accident having occurred.

8. The smartphone of claim 7 wherein the alert from the paired device is accompanied by GPS coordinates, which are provided along with at least some of the pre-programmed communications

9. The smartphone of claim 7 wherein the smartphone has a Global Positioning System, and GPS coordinates are provided along with at least some of the pre-programmed communications.

10. The smartphone of claim 7 wherein the alert is accompanied by specific information or data about the accident, including one or both of rollover or air bags deployed.

11. The smartphone of claim 7 wherein the pre-programmed communications include one or more of emails, text messages or recorded voice messages.

12. The smartphone of claim 7 wherein the pre-programmed communications include an alert to an Internet-connected server that an accident has occurred.

13. The smartphone of claim 7 wherein the wireless pairing circuitry is Bluetooth™ protocol compatible.

14. A system comprising:
an alert apparatus having a digital processor, an accelerometer, wireless pairing circuitry, and an onboard diagnostics (OBD) connecter, the alert apparatus enabled to retrieve data from an automobile OBD system, and to determine from local and retrieved data that an accident has occurred;
a smartphone executing an application enabled to receive an alert from the alert apparatus, and to send as a result pre-programmed communications to pre-configured destinations that an accident has occurred; and
an Internet-connected server enabled to receive an alert as a pre-programmed communication from the smartphone and to send as a result pre-programmed communications to pre-configured destinations that an accident has occurred.

15. The system of claim 14 wherein the smartphone sends GPS coordinates along with pre-programmed communications.

16. The system of claim 15 wherein one or more of the pre-programmed communications comprise requests for service from one or more emergency service organizations.

17. A method comprising:
monitoring onboard diagnostics information of an automobile by an alert apparatus having an accelerometer and wireless pairing circuitry;
determining by the alert device that an accident has occurred;
sending an accident alert to a smartphone via the wireless pairing circuitry;
transmitting by the smartphone one or more preprogrammed communications to one or more pre-configured destinations as a result of receiving the alert.

18. The method of claim 17 wherein one of the pre-programmed communications is to an Internet-connected server that transmits one or more communications to one or more pre-configured destinations as a result of receiving the alert.

19. The method of claim 17 wherein the smartphone either receives GPS coordinates from the alert device, or generates the coordinates in the smartphone, and sends the GPS coordinates along with one or more of the pre-programmed communications.

20. The method of claim 19 wherein one or more of the pre-programmed communications is a request for service from one or more emergency service organizations.
